(19) United States
(12) Patent Application Publication
(10) Pub. No.: US 2024/0252987 A1
(43) Pub. Date: Aug. 1, 2024

(54) PARTICLE FILTRATION

(71) Applicant: UNIVERSITY OF CONNECTICUT, Farmington, CT (US)

(72) Inventors: Antonio P. COSTA, Farmington, CT (US); Diane J. BURGESS, Farmington, CT (US)

(21) Appl. No.: 18/566,217

(22) PCT Filed: Jun. 3, 2022
(86) PCT No.: PCT/US2022/032113

§ 371 Date: Dec. 1, 2023

Related U.S. Application Data
(60) Provisional application No. 63/196,563, filed on Jun. 3, 2021.

(51) Int. Cl. B01D 61/22; B01D 61/14; B01D 61/18; B01D 65/08

(52) U.S. Cl. CPC B01D 61/22; B01D 61/145; B01D 61/18; B01D 65/08; B01D 2313/025; B01D 2313/221; B01D 2313/243; B01D 2313/60; B01D 2313/701; B01D 2315/10; B01D 2315/16

(57) ABSTRACT

An apparatus, comprising: a membrane; a membrane holder including an output, wherein the membrane holder is operable to hold the membrane and the membrane holder has three or more ports, and a permeate attachment coupled to the output of the membrane. The apparatus may further comprise a flow meter coupled to an output of a first pump, wherein the flow meter is disposed between the pump and the membrane holder.

### CROSS-REFERENCE

This application claims priority to U.S. Provisional Patent Application Ser. No. 63/196,563 filed Jun. 3, 2021, incorporated by reference herein in its entirety.

### BACKGROUND

Ultrafiltration is a membrane separation process that uses finely porous membranes to separate water and microsolutes from macromolecules and colloids. Ultrafiltration membranes operate by permeating water and small solutes and rejecting the larger dissolved or suspended materials. A driving force for water permeation is provided by applying an elevated pressure to the feed liquid or a reduced pressure on the permeate side, or both. At least at low pressure, the water flux through the membrane increases with increasing pressure difference across the membrane.

Ultrafiltration membranes arm very susceptible to fouling. Fouling occurs when contaminants such as charged solutes, oils, bacteria, colloidal materials of various types, and suspended particulates become trapped on the surface or in the pores of the membrane. In addition to clogging pores, the accreting material forms a thickening gel layer on the membrane surface that presents an increasing resistance to water permeation. Thus, fouling impairs the membrane performance by progressively diminishing the transmembrane flux. For a short time, the increasing resistance presented by the fouling layer can be overcome by increasing the pressure driving force.

Despite use of the above procedures and operating protocols, fouling continues to be a significant problem in at least some applications and reduces the efficiency of many ultrafiltration processes. Thus, there remains a need for less fouling ultrafiltration membranes.

### SUMMARY

The present disclosure describes systems, apparatuses, and methods for processing particles. In certain embodiments, the disclosure may describe a system for filtering particles (e.g., a modified UF/DF/TFF filtration system).

In one aspect, disclosed herein is an apparatus, comprising
a membrane;
a membrane holder including an output, wherein the membrane holder is operable to hold the membrane, and the membrane holder has three or more ports; and
a permeate attachment coupled to the output of the membrane.

In some embodiments, the apparatus comprises a flow meter coupled to an output of the permeate attachment.

In some embodiments, the apparatus further comprises a pump coupled to an input of the membrane holder.

In some embodiments, the apparatus further comprises a flow meter disposed between the pump and the membrane holder.

In some embodiments, the apparatus further comprises a pressure sensor coupled to the membrane holder.

The apparatuses of the invention may further comprise additional sensors, including, but not limited to, particle size analyzers, concentration sensors. pH sensors, conductivity sensors, refractive index sensors, electromagnetic spectra sensors, and temperature sensors.

In one aspect, disclosed herein is an apparatus, comprising:
a membrane;
a membrane holder including a first output, wherein the membrane holder is operable to hold the membrane, and the membrane holder has three or more ports;
a permeate attachment coupled to the first output of the membrane; and
a flow meter coupled to an output of the permeate attachment.

In some embodiments, the apparatuses of the invention may further comprise a pressure sensor coupled to the input of the membrane holder, wherein the pressure sensor is enabled to detect a pressure of a liquid passing through the pressure sensor.

In some embodiments of the invention, a flow meter is disposed between the first pump and the membrane holder; and a pressure sensor is coupled to the flow meter, wherein the pressure sensor is enabled to detect a pressure of a liquid passing through the pressure sensor and regulate an output of the flow meter.

In some embodiments, the apparatuses of the invention further comprise one or more heat exchangers in fluid communication with one or more flow meters.

In some embodiments, the apparatuses of the invention further comprise a pressure regulator coupled to at least one flow meter. In some embodiments, the pressure regulator comprises a tube. In some embodiments, the tube restricts liquid flow to modify a pressure of the liquid passing through the pressure sensor. In some embodiments, the tube is a metal tube. In other embodiments, the tube is a plastic tube. In some embodiments, the pressure regulator is a back pressure regulator. In some embodiments, the pressure regulator is a pinch valve.

In some embodiments, the apparatuses of the invention further comprise a valve coupled to the permeate attachment.

In some embodiments, the apparatuses of the invention further comprise one or more three-way ports, wherein each three-way port comprises an inlet and an outlet.

In some embodiments, the apparatuses of the invention further comprise one or more vessels.

In some embodiments, the apparatuses of the invention further comprise comprising one of more static mixers, wherein each static mixer is in fluid communication with an outlet of a three-way port.

In some embodiments, the apparatuses of the invention further comprise one or more turbulent jet mixers, wherein each turbulent jet mixer is in fluid communication with an outlet of a three-way port.

In some embodiments, the apparatuses of the invention comprise a permeate attachment, which comprises single-use, plastic components. In other embodiments, the apparatuses of the invention comprise a permeate attachment, which comprises metal components. In some such embodiments, the metal components are stainless steel. In yet other embodiments, the apparatuses of the invention comprise a permeate attachment, which comprises a mixture of plastic components and metal components.

In some embodiments, the apparatuses of the invention further comprise a second pump disposed between the membrane holder and a second flow meter, wherein the second flow meter is coupled to the input of the pressure regulator.

In some embodiments, the apparatuses of the invention further comprise a third flow meter coupled to an input of the permeate attachment.

In some embodiments, the apparatuses of the invention comprise ultrasonic flow meters.

In some embodiments, the apparatuses of the invention comprise gear pumps.

In one aspect, disclosed herein is a system, comprising:
an apparatus of the invention;
a memory; and
a processor in communication with the memory, wherein the processor is configured to execute the following steps:
(a) receiving a liquid at the apparatus;
(b) processing the liquid via the apparatus, wherein the liquid travels through the membrane and the permeate attachment; and
(c) optionally, monitoring a state of the liquid during processing.

In some embodiments of the system, processing the liquid via the apparatus comprises one or more feedback loops.

In some embodiments of the system, processing the liquid via the apparatus comprises one or more analyzers in fluid communication with the retentate output of the membrane holder.

In some embodiments of the system, processing the liquid via the apparatus comprises one or more pump controls.

In some embodiments of the system, processing the liquid via the apparatus comprises one or more pressure controls.

In some embodiments of the system, monitoring a state of the liquid during processing comprises flow rate monitoring.

In some embodiments of the system, monitoring a state of the liquid during processing comprises pressure monitoring.

In some embodiments, the system further comprises a controller. In some such embodiments, the controller is configured to:
determine concentration of the liquid during processing;
compare said concentration to a setpoint; and
adjust one or more parameters of the system in response to the difference between the concentration of the liquid during processing and the concentration of the setpoint.

In some embodiments of the system, flow rate is adjusted in response to the difference between the concentration of the liquid during processing and the concentration of the setpoint.

In some embodiments, the system further comprises an analyzer, wherein the analyzer is in communication with the apparatus. In some such embodiments, the analyzer is selected from an ultra-violet/visible light spectrometer, a Raman spectrometer, a near-infrared spectrometer, a fluorescence spectrometer, a dynamic light scattering detector, a surface charge detector, a turbidity sensor, and a combination thereof.

In one aspect, disclosed herein is a method for the continuous processing of particles, the method comprising:
receiving a liquid at an apparatus of the invention;
processing the liquid via the apparatus; and
optionally, monitoring a state of the liquid during processing.

In some embodiments of the method, processing the liquid via the apparatus comprises the liquid traveling through the membrane and the permeate attachment.

In some embodiments of the method, processing the liquid via the apparatus comprises using one or more feedback loops.

In some embodiments of the method, processing the liquid via the apparatus comprises using one or more analyzers in fluid communication with the retentate output of the membrane holder.

In some embodiments of the method, processing the liquid via the apparatus comprises using one or more pump controls.

In some embodiments of the method, processing the liquid via the apparatus comprises using one or more pressure controls.

In some embodiments of the method, monitoring a state of the liquid during processing comprises flow rate monitoring.

In some embodiments of the method, monitoring a state of the liquid during processing comprises pressure monitoring.

In one aspect, disclosed herein is a non-transitory computer readable medium having stored thereon instructions, that when executed by one or more processors, cause a system for the continuous processing of particles to perform operations comprising:
receive a liquid at an apparatus of the invention;
process the liquid via the apparatus; and
optionally, monitor a state of the liquid during processing.

In some embodiments of the non-transitory computer readable medium, the process operation comprises the liquid traveling through the membrane and the permeate attachment.

In some embodiments of the non-transitory computer readable medium, the process operation comprises using one or more feedback loops.

In some embodiments of the non-transitory computer readable medium, the process operation comprises using one or more analyzers in fluid communication with the retentate output of the membrane holder.

In some embodiments of the non-transitory computer readable medium, process operation comprises using one or more pump controls.

In some embodiments of the non-transitory computer readable medium, the process operation comprises using one or more pressure controls.

In some embodiments of the non-transitory computer readable medium, the monitor operation comprises flow rate monitor.

In some embodiments of the non-transitory computer readable medium, the monitor operation comprises a pressure monitor.

### BRIEF DESCRIPTION OF THE FIGURES

FIG. 1 shows one exemplary apparatus of the present invention comprising a membrane holder and the permeate attachment.

FIG. 2 details one exemplary permeate attachment and the components thereof for inclusion in the apparatuses of the present invention.

FIG. 3 shows one exemplary apparatus of the present invention comprising multiple pumps, flow meters, a pressure sensor, a pressure regulator, and a permeate attachment.

FIG. 4 shows one exemplary apparatus of the present invention of the present invention comprising a degassing unit on the retentate side of the membrane holder.

FIG. 5 details one exemplary permeate attachment comprising a pressure valve and pressure vessel for inclusion in the apparatuses of the present invention.

FIG. 6 show an exemplary apparatus of the present invention comprising two or more UF/DF/TFF membrane holder systems.

FIG. 7 details one exemplary permeate attachment in which liquid enters from the permeate port of the membrane holder for inclusion in the apparatuses of the present invention.

FIG. 8 details one exemplary permeate attachment comprising one or more valves and one or more sensors for inclusion in the apparatuses of the present invention.

FIG. 9 details one exemplary apparatus of the present invention.

FIG. 10 details one exemplary computer program product of the present invention.

FIG. 11A shows an exemplary embodiment in which feed flow rate into the membrane holder is shown pulsing to go to a high and low state.

FIG. 11B shows an exemplary embodiment in which retentate flow rate is stabilized as a constant-state even though the feed flow rate pulses and the membrane is pressurizing/depressurizing.

FIG. 11C shows an exemplary embodiment in which pressure across the membrane pulses with the flow rate. Pressure does not exceed high pressure limits of the membrane holder, hence, reduction in fouling over long periods of time.

FIG. 12 shows an exemplary embodiment demonstrating reaching a constant-state concentration of lipid at the retentate of the membrane holder. One or more sensors integrated in the process stream using predictive algorithms are used to determine the lipid concentration.

### DETAILED DESCRIPTION

Generally, continuous manufacturing of nanoparticles enables the growth of new nanomedicines and other nanoparticle forms. Often, one aspect of nanoparticle processing includes particle concentrating and buffer exchange (i.e., ultrafiltration and diafiltration (UF/DF) and tangential flow filtration (TFF)). For a fully continuous operation, typically, a particle UF/DF/TFF process needs to be single-pass. Traditionally, a single-pass UF/DF/TFF operation should not recirculate the processing medium into a common vessel; material thus only is processed a single time, enabling continuous flow downstream.

Generally, a UF/DF/TFF apparatus includes a holder, membranes, pumps, meters, pressure, temperature, and conductivity sensors. Often, a holder also includes additional attachments such as end plates and diverter plates to direct liquid flow through the membrane. Typically, membranes can be of a certain material, molecular weight cut-off (MWCO), and surface area. Generally, membranes also can have two or more compartments, such as the retentate and permeate sides. Often, processing fluid enters a feed port, and any retained material (e.g., nanoparticles) exits the retentate port, whereas a permeate is material that leaves the processing fluid path and is not retained by the membrane properties, such as the MWCO. Generally, membranes (also referred to as cassettes) can be in an open and closed format.

A common approach of operating an ultrafiltration/diafiltration system in single-pass is to run at low, constant flow rates and monitor the system pressure, which continuously increases over time. Typically, as pressure increases over time the membrane becomes fouled with the processing material and the pressure reaches a pressure limitation. Generally, when the pressure limitation is reached, the process must then be shut down for cleaning. Thus, conventionally there is a limited useful runtime for the UF/DF/TFF process.

In various embodiments, the present disclosure describes an invention directed to apparatuses that may enable an operation of a UF/DF/TFF system and may allow for reduced membrane fouling. In certain embodiments, apparatuses described herein may enable longer operational runtimes of a UF/DF/TFF system. In many embodiments, operating multiple systems in series may permit a system to afford higher concentration and dilution factors. In certain embodiments, the present disclosure may describe methods for continuous operation of a UF/DF/TFF system.

The apparatuses and methods of the present invention has many industrial applications, including, but not limited to, the pharmaceutical, cosmetic and beverage industries.

### Definitions

Throughout the present specification and the accompanying claims the words “comprise,” “include,” and “have” and variations thereof such as “comprises,” “comprising,” “includes,” “including,” “has,” and “having” are to be interpreted inclusively. That is, these words are intended to convey the possible inclusion of other elements or integers not specifically recited, where the context allows. No language in the specification should be construed as indicating any non-claimed element essential to the practice of the invention.

The terms “a,” “an,” and “the” and similar referents used in the context of describing the invention (especially in the context of the following claims) are to be construed to cover both the singular and the plural, unless otherwise indicated herein or clearly contradicted by context.

As used herein, the term “about” refers to a range of values of plus or minus 5% of a specified value. For example, the phrase “about 200” includes plus or minus 5% of 200, or from 190 to 210, unless clearly contradicted by context.

Illustrations are for the purpose of describing a preferred embodiment of the invention and are not intended to limit the invention thereto. For example, the particular arrangements shown in the Figures should not be viewed as limiting. Other embodiments may include more or less of each element shown in a given Figure. Further, some of the illustrated elements may be combined or omitted. Additionally, an example embodiment may include elements that are not illustrated in the Figures.

The headings used herein are for organizational purposes only and are not meant to be used to limit the scope of the description or the claims, which can be had by reference to the specification as a whole. Accordingly, the terms defined immediately below are more fully defined by reference to the specification in its entirety.

All methods described herein can be performed in any suitable order unless otherwise indicated herein or otherwise clearly contradicted by context. Further, all methods described herein and having more than one step can be performed by more than one person or entity. Thus, a person or an entity can perform step (a) of a method, another person or another entity can perform step (b) of the method, and a yet another person or a yet another entity can perform step (c) of the method, etc. The use of any and all examples, or exemplary language (e.g., “such as”) provided herein is intended merely to better illuminate the invention and does not pose a limitation on the scope of the invention otherwise claimed.

Exemplary methods and devices are described herein. The words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

As used herein, “optional” or “optionally” means that the subsequently described event or circumstance may or may not occur, and that the description includes instances where said event or circumstance occurs and instances where it does not.

Recitation of ranges of values herein are merely intended to serve as a shorthand method of referring individually to each separate value falling within the range, unless otherwise indicated herein, each individual value is incorporated into the specification as if it were individually recited herein. Ranges may be expressed herein as from “about” (or “approximately”) one particular value, and/or to “about” (or “approximately”) another particular value. When such a range is expressed, another embodiment includes from the one particular value and/or to the other particular value. Similarly, when values are expressed as approximations, by use of the antecedent “about” or “approximately” it will be understood that the particular value forms another embodiment. It will be further understood that the endpoints of each of the ranges are disclosed both in relation to the other endpoint, and independently of the other endpoint.

The term “ultrafiltration” includes nanofiltration.

### Particle Filtration

In various embodiments, the present disclosure describes systems, apparatuses, and methods for processing particles. In certain embodiments, the disclosure may describe a system for filtering particles (e.g., a modified UF/DF/TFF filtration system). In many embodiments, the modified UF/DF/TFF filtration system has several advantages, such as, for example: (1) enhanced filtration control, which may be enabled to supporting continuous manufacturing; (2) an ability to reach a controlled-state concentration; (3) longer operation time; (4) reduced membrane fouling (5) single-pass and recirculating capabilities; and/or (6) enhanced cleaning capabilities of the membrane.

In various embodiments, an apparatus for modified UF/DF/TFF filtration may include a membrane, a membrane holder including an output, wherein the membrane holder is operable to hold the membrane; and a permeate attachment coupled to the output of the membrane.

In at least one embodiment, the apparatus may further comprise a flow meter coupled to an output of the permeate attachment. In some embodiments, a flow meter may be disposed between a pump and a membrane holder. In some embodiments, a pressure sensor may be coupled to a flow meter, wherein a pressure sensor may regulate an output of the flow meter.

In some embodiments, the apparatuses of the present invention may further comprise a pump coupled to an input of the membrane holder.

In some embodiments, the apparatuses of the present invention may further comprise a membrane; a membrane holder including an output, wherein the membrane holder is operable to hold the membrane; a permeate attachment coupled to the output of the membrane; a flow meter coupled to an output of the permeate attachment; a pump coupled to an input of the membrane holder, the flow meter is disposed between the pump and the membrane holder, wherein the flow meter is disposed between the pump and the membrane holder; and a pressure sensor is coupled to the flow meter, wherein the pressure sensor regulates an output of the flow meter.

In some embodiments, the membrane holder may operate in a single-pass, continuous operation. In other embodiments, the membrane holder operates in a recirculating mode. The material entering the membrane holders can be, for example, an aqueous solution, a colloidal dispersion, or a suspension. In some embodiments, the material may consist of particles of any size from nanometer to micrometer sizes.

In some embodiments, the apparatuses of the present invention may further comprise conduits and connected flow paths that provide control over the flow direction in the membrane holder and one or more membranes.

In some embodiments, the apparatuses of the present invention may further comprise one or more conduits coupled to the permeate of the membrane holder. In some embodiments, the conduits comprise chambers. In these embodiments, these chambers may act as a temporary reservoir for the permeate fluid, which exits the apparatus as waste or recyclable material. In some embodiments, an air pathway may be coupled to a conduit, which acts to depressurize the permeate process lines. In some embodiments, a hydrostatic pressure/depressurization cycle is formed on the membranes in the membrane holder.

In some embodiments, the permeate attachment comprises a three-way port that is coupled to other components of the permeate attachment via an optional conduit at each port. For example, in some embodiments, the three-way port may be coupled to the output of the permeate port via an optional conduit. In some embodiments, the three-way port is coupled to the air input via an optional conduit. In some embodiments, the three-way port is coupled to the permeate attachment output via an optional conduit.

In some embodiments, the permeate attachment comprises a three-way port. In some embodiments, each of the ports on the three-way port has the same or a different port. In some embodiments, each of the ports on the three-way port has the same or a different diameter. In some embodiments, the type of port is a barbed fitting. In some embodiments, the type of port is a sanitary fitting.

In some embodiments, the port is coupled to the air intake and has a volume that prevents liquid from coming in physical contact with the air filter. In some embodiments, the air filter may be hydrophobic and prevents aqueous liquid from passing through the air filter. In some such embodiments, during pressurization and depressurization cycles, the liquid in the permeate attachment exits the permeate attachment to the waste collection and air enters into the permeate attachment.

In some embodiments, an apparatuses of the present invention can reduce long-term fouling of the membrane. In certain embodiments, fouling may occur where material that is loaded into the apparatus remains suspended on the retentate side. Thus, to avoid such membrane fouling, in some embodiments, the apparatus of the present invention may provide pulsating of the flow rate in and out of the system. In some embodiments, pulsation may be used to obtain a constant concentration of the retentate liquid material. In some embodiments, pulsation of liquid lines may be used to concentrate the processing liquid. In some embodiments, pulsation may be used to control the concentration of the retentate.

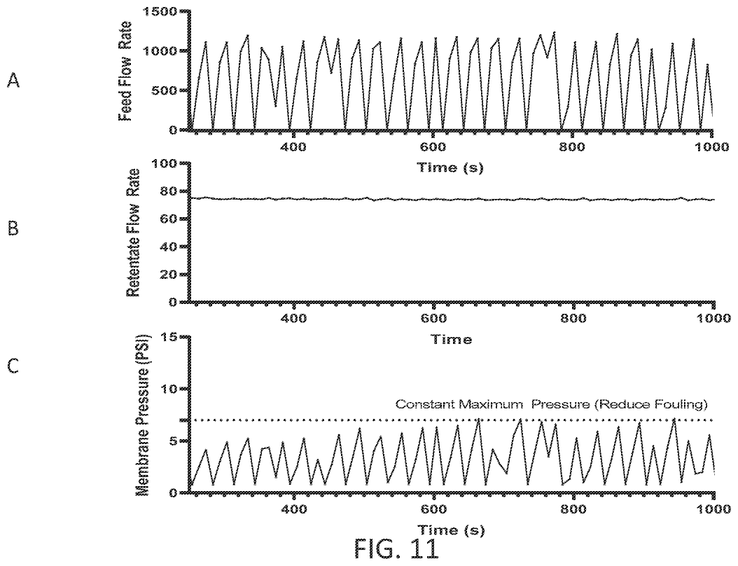

For example, in at least one embodiment, nanoparticles of 100 nm in diameter can foul a membrane, reducing the permeate flow rate and increasing the pressure of the system. In some instances by depressurizing the membrane the fouled nanoparticles are dispersed in the retentate feed. In other instances, by reversing the permeate flow for a period of time, the fouled nanoparticles are dispersed in the retentate feed. The pulse duration in the high and low states and ramping of the flow rates prevent long-term fouling of the membrane. See FIG. 11A, showing an embodiment in which feed flow rate into the membrane holder is shown is pulsing to go to a high and low state.

In some embodiments, the pulsing of the pump may be represented by a square wave, a triangle wave or non-linear repeating unit causing the pump to change flow rate.

In some embodiments, the apparatuses of the invention further comprise a pressure regulator coupled to at least one flow meter. In some embodiments, the flow meter is coupled to a pump and the pump is coupled to the retentate port of the membrane holder. In some embodiments, a degassing unit, comprising multiple silicone tubes is coupled to the pressure regulator. In some embodiments, the tube restricts liquid flow to modify a pressure of the liquid passing through flow meter. In some embodiments, the flow meter operates at sufficient pressure to produce a constant flow rate when liquid entering the pump is subject to a pressurization and depressurization cycle. In some embodiments, the membrane holder comprises a chamber with a volume of liquid to support the constant flow rate of the pump output.

In some embodiments, the pressure regulator generates a back pressure to allow for the retentate flow rate to be constant. In some embodiments, the pressure can fluctuate on the membrane holder when operating in pulse mode. In some embodiments, if the output of a flow meter is pressurized (via the pressure regulator or small internal diameter tube), then the flow rate is more constant. Otherwise, the flow rate would rapidly vary as the membrane holder depressurizes/pressurizes. FIG. 11B shows an exemplary embodiment in which retentate flow rate is stabilized as a constant-state even though the feed flow rate pulses and the membrane is pressurizing/depressurizing. This constant retentate flow rate enables a constant concentration of nanoparticles to output the membrane holder. FIG. 11C shows an exemplary embodiment in which pressure across the membrane pulses with the flow rate. This pressure is kept at a low pressure (e.g. 10 psi) and it does not exceed the high pressure limits of the membrane holder (e.g. 60 psi). The low pressure state reduces membrane fouling and enables continuous, single-pass operation of this system.

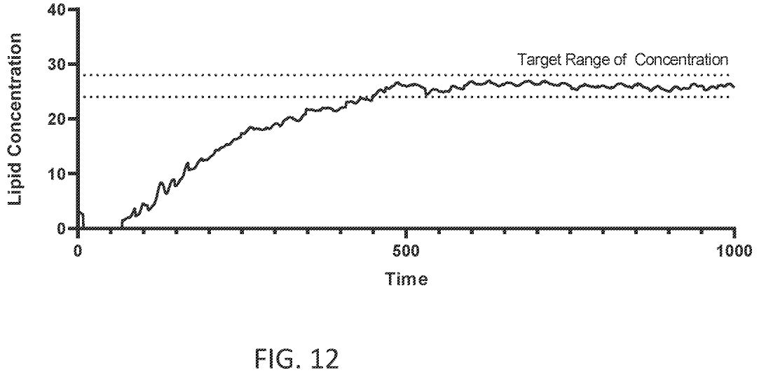

For example, the pulsing will be a square wave when the pump operates at two liters per minute for 10 seconds and 0 liters per minute for 10 seconds, and the pressure regulator is a tube where a pressure gradient develops as liquid flows through the tube. The retentate pump maintains a constant flow rate (e.g., 100 mL/min) and the feed pumps operate by a pulse signal. In this manner, the membrane holder is pressurized and depressurized in a cyclic manner, resulting in a reduction and prevention of membrane fouling by the particles. The constant flow rate of the retentate pump enables the concentration to reach a controlled state, for example, 20 millimolar lipid. Moreover, the pressure regulator device, such as a valve or tube, can provide sufficient back pressure such that the retentate pump does not deviate by more than 30 percent of the user specified flow rate. Tuning the back pressure can provide low deviation from the user specified flow rate and a controlled lipid concentration on the output of the system. FIG. 12 shows an exemplary embodiment demonstrating reaching a constant-state concentration of lipid at the retentate of the membrane holder. One or more sensors integrated in the process stream using predictive algorithms are used to determine the lipid concentration. In addition to lipid concentration, other attributes such as nanoparticle concentration, residual solvent, excipient concentrations, active ingredient concentration, pH, pressure, conductivity and refractive index, among other commonly measured attributes, can be measured and used to control process parameters.

In some embodiments, provided herein are apparatuses comprising (a) a membrane holder for UF/DF/TFF, (b) one or more membranes, (c) a permeate attachment, and (d) an output. In some such embodiments, the permeate attachment comprises one or more conduits that are connected to the permeate port of the membrane holder. In some embodiments, the first port of a three-way port is in fluid communication with a first conduit. In some embodiments, the second port is in fluid communication with a second conduit. In some embodiments, the air input is in fluid communication with the second conduit. In some embodiments, the third port is in fluid communication with a third conduit. In some embodiments, the air input can be further be connected to a bioburden reduction filter or a pressurized air source.

In some embodiments, provided herein are apparatuses comprises (a) one or more membrane holders for UF/DF/TFF, (b) one or more membranes, (c) one or more permeate attachments, (d) one or more outputs. (e) one or more pumps, (f) one or more flow meters, (g) one or more pressure regulators, and (f) one or more pressure sensors. In some such embodiments, the permeate attachment comprises one or more conduits that are connected to the permeate port of the membrane holder. In some embodiments, the first port of a three-way port is in fluid communication with a first conduit. In some embodiments, the second port is in fluid communication with a second conduit. In some embodiments, the air input is in fluid communication with the second conduit. The third port is in fluid communication with a third conduit. In some embodiments, a pump and a flow meter are in fluid communication with the feed port of the membrane holder. In some embodiments, a pump and flow meter are in fluid communication with the retentate port on the membrane holder. In some embodiments, a pressure regulator is in fluid communication with the flow meter. In some embodiments, an output can be connected to a container for waste or recycling. In some embodiments, an output is in fluid communication with a degassing unit. In some embodiments, an output is in fluid communication with one or more sensors. Such sensors can be used to monitor material attributes of the processing fluid. Exemplary sensors may include turbidity, ultra-violet-visible spectroscopy, Raman spectroscopy, refractive index, pressure, conductivity, and pressure sensors. The concentration of the particles can be determined by the one or more sensors. This determination may be done using predictive algorithms, neural networks and other predictive modeling tools.

In some embodiments, the permeate attachment has a pressure regulator in fluid communication with the air input and a pressure vessel. In some such embodiments, the pressurized, reverse flow of the permeate liquid can be used to reduce membrane fouling and for faster cleaning.

In some embodiments, disclosed herein are apparatuses comprising a three-way port and a vessel. In some embodiments, the first port of the three-way port is in fluid communication with a vessel. In some embodiments, the vessel contains an aqueous dilution medium. In some embodiments, the second port is in fluid communication with the pressure regulator on the retentate liquid stream of the first membrane holder. In some embodiments, the third port is in fluid communication with the feed pump on the feed liquid stream of the second membrane holder. In some embodiments, a mixer is in fluid communication with the third port. In some such embodiments, the mixer is a static mixer or a turbulent jet mixer.

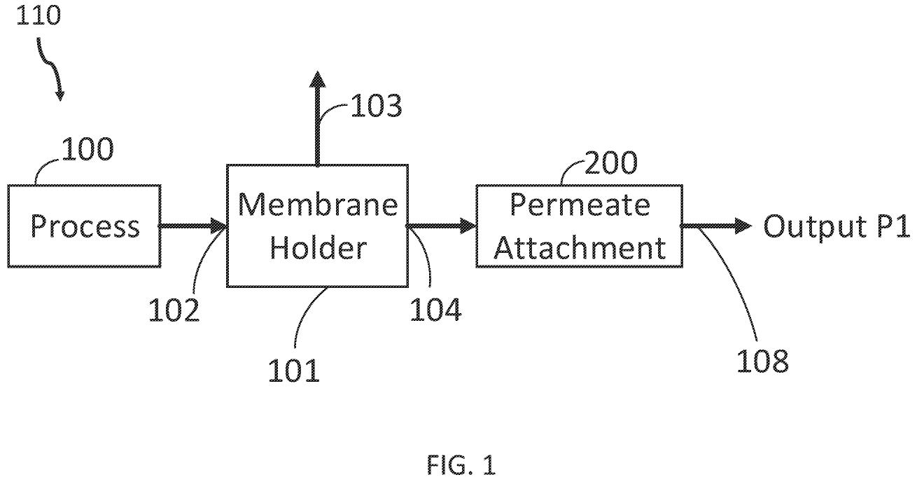

The example embodiment of FIG. 1 illustrates a modified UF/DF/TFF system for filtering particles. As shown, the UF/DF/TFF system 110 includes a membrane holder 101 and the permeate attachment 200. The UF/DF/TFF is coupled to process 100. The membrane holder 101 includes a feed port 102, a permeate port 104, and a retentate port 103. The permeate attachment 200 includes an output 108. The process 100 is any existing process and/or device that may be used to prepare particles. In this embodiment, prepared particles from process 100 flow through the membrane holder 101 to permeate attachment 200 and outputs via output 108.

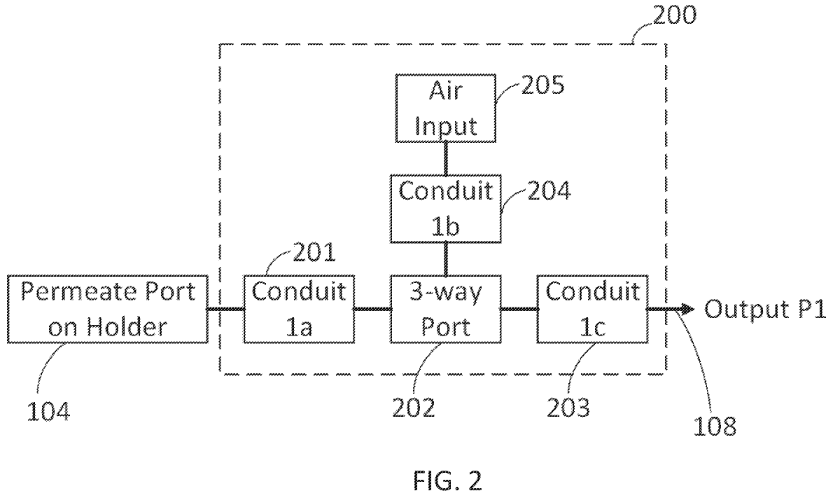

The example embodiment of FIG. 2 illustrates components of a permeate attachment, in accordance with at least one embodiment of the present disclosure. As shown, permeate attachment 200 includes a permeate port 104, conduit 201, conduit 204, 3-way port 202, conduit 203, permeate attachment output 108, and air input 205.

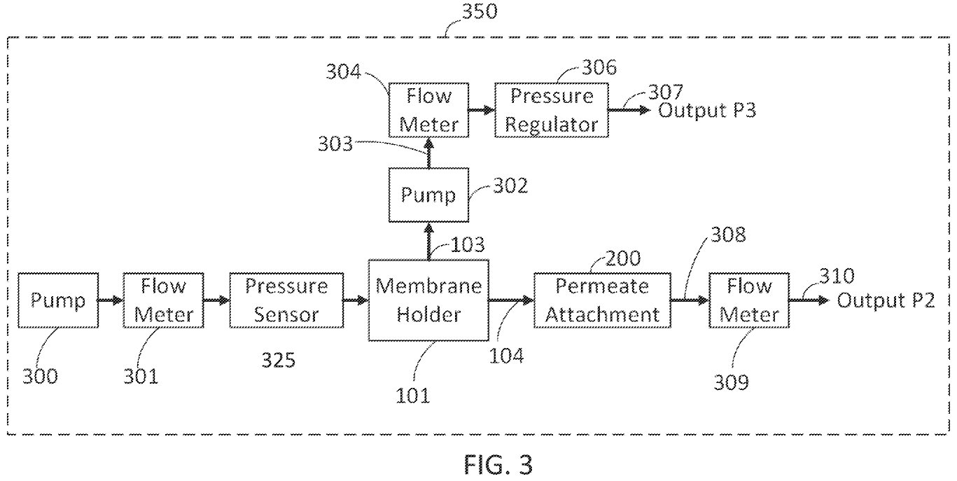

The example embodiment of FIG. 3 illustrates a full UF/DF/TFF system, in accordance with at least one embodiment of the present disclosure. As shown, the full UF/DF/TFF system 350 includes a feed pump 300, a feed flow meter 301, a pressure sensor 325, a feed port 102, a membrane holder 101, a permeate port 104, a retentate port 103, a permeate attachment 200, a retentate pump 302, a retentate pump output 303, a retentate flow meter 304, a pressure regulator 306, a retentate line output 307, a permeate attachment output 308, a permeate attachment flow meter 309, and a flow meter output 310.

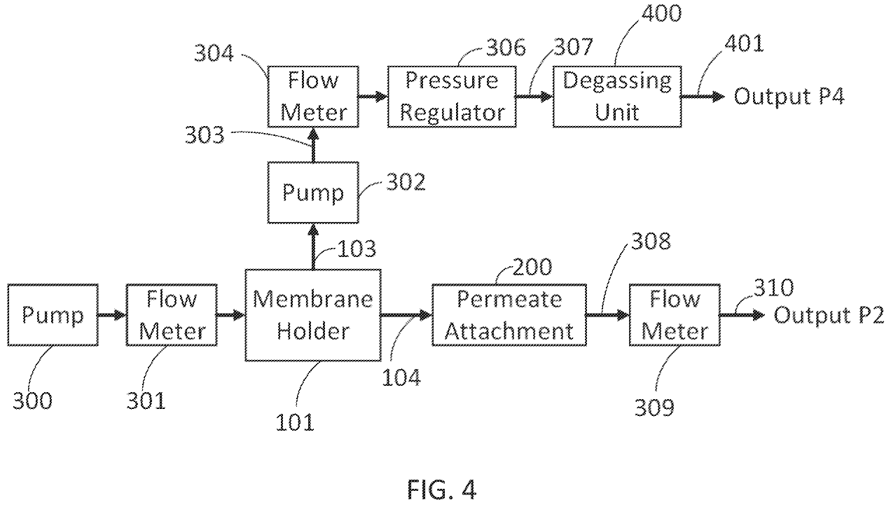

The example embodiment of FIG. 4 illustrates an alternate embodiment of a full UF/DF/TFF system, in accordance with at least one embodiment of the present disclosure. As shown, a degassing unit is included on a retentate side of a membrane holder. The full UF/DF/TFF system includes a feedpump 300, a feedflow meter 301, a pressure sensor, a feed port 102, a membrane holder 101, a permeate port 104, a retentate port 103, a permeate attachment 200, a retentate pump 302, a retentate pump output 303, a retentate flow meter 304, a pressure regulator 306, a retentate line output 307, a permeate attachment output 307, a permeate attachment flow meter 309, a flow meter output 310, a degassing unit 400, and a degassing unit output 401.

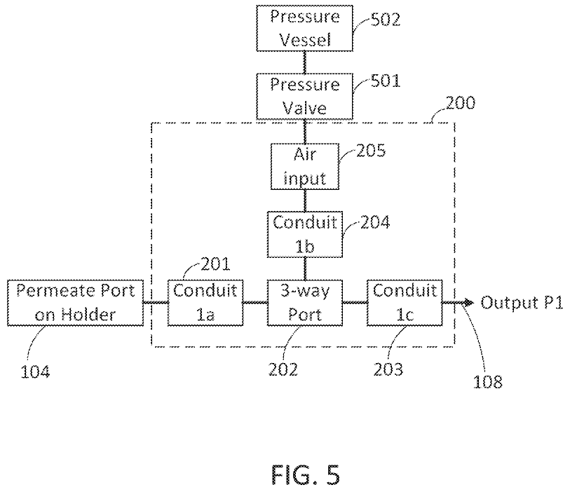

The example embodiment of FIG. 5 is an alternate example of a permeate attachment, in accordance with at least one embodiment of the present disclosure. As shown, a permeate attachment includes a permeate port 104, a conduit 201, a conduit 204, a three-way port 202, a conduit 203, a permeate attachment output 108, an air input 205, a pressure valve 501, and a pressure vessel 502.

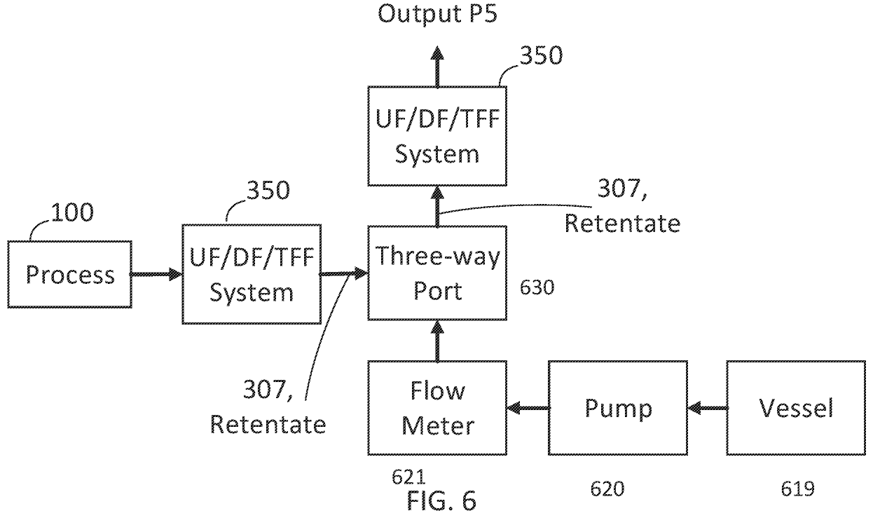

The example embodiment of FIG. 6 illustrates two or more UF/DF/TFF membrane holder systems, in accordance with at least one embodiment of the present disclosure. As shown, a three-way port 630 is used to connect flow meter 621 and pump 620 for the dilution of retentate 307 in a first UF/DF/TFF system. A mixer may be included downstream from the three-way port 630. In this embodiment, prepared particles from process 100 flow through a first UF/DF/TFF system 350 to a three-way port 630 via a first port to a second UF/DF/TFF system 350 and outputs to an output. As shown, a flow meter 621, a pump 620, and a vessel 619 are coupled to the three-way port 630 via a second port.

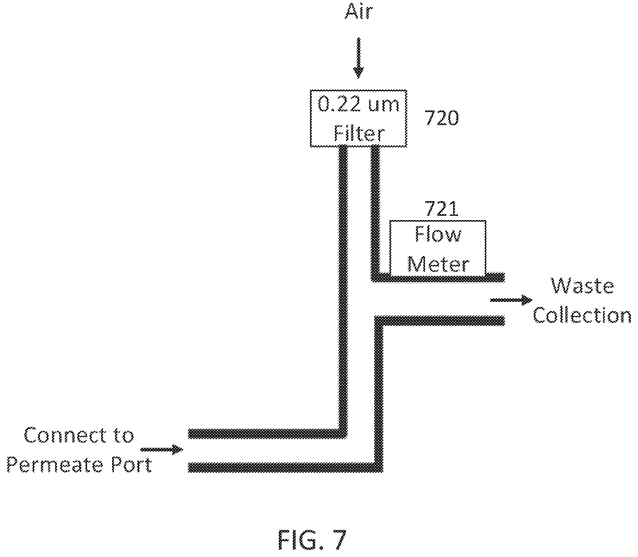

The example embodiment of FIG. 7 illustrates a permeate attachment, in accordance with an embodiment of the present disclosure. As shown, the permeate attachment, where liquid enters from the permeate port of the membrane holder. Liquid flows towards the waste collection. The 0.22 micron filter 720 is connected to the air intake of the three way port enabling air to enter into the permeate attachment and preventing liquid from leaving the permeate attachment.

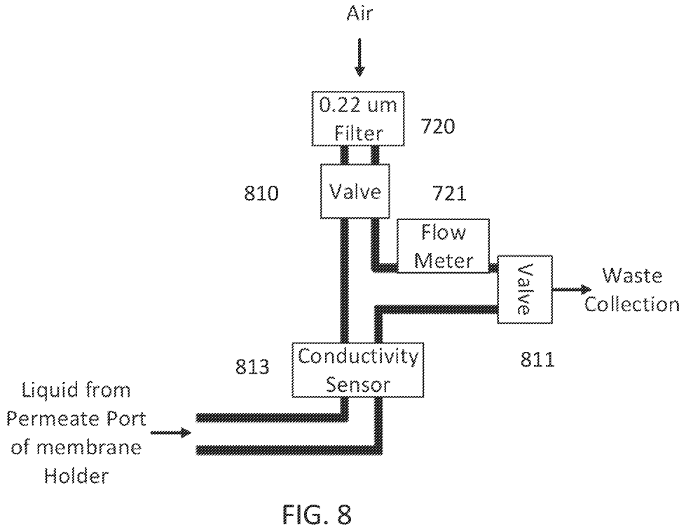

The example embodiment of FIG. 8, which is an alternate permeate attachment, in accordance with an embodiment of the present disclosure. As shown, the permeate attachment, wherein the system further includes one or more valves 810,811 and one or more sensors 813. The sensor may be a conductivity sensor, pressure sensor, or a pH sensor. The sensors may be in a flow cell configuration, enabling the liquid to pass through the sensor to the waste collection. The valves can be used to restrict flow and generate a back pressure or completely close a flow path of the permeate attachment.

### Systems and Methods

### Systems

In some embodiments, provided herein is a system for the continuous processing of particles. In some such embodiments, the system comprises an apparatus of the invention, a memory, and a processor in communication with the memory. The processor is configured to execute the following: receiving a liquid at the apparatus; processing the liquid via the apparatus, wherein the liquid travels through the membrane and the permeate attachment; and, optionally, monitoring a state of the liquid during processing.

In some embodiments, processing the liquid via the apparatus comprises one or more feedback loops.

In some embodiments, processing the liquid via the apparatus comprises one or more analyzers in fluid communication with the retentate output of the membrane holder.

In some embodiments, processing the liquid via the apparatus comprises one or more pump controls.

In some embodiments, processing the liquid via the apparatus comprises one or more pressure controls.

In some embodiments, monitoring a state of the liquid during processing comprises flow rate monitoring.

In some embodiments, monitoring a state of the liquid during processing comprises pressure monitoring.

In some embodiments, the system further comprising a controller. In some such embodiments, the controller is configured to determine concentration of the liquid during processing; compare said concentration to a setpoint; and adjust one or more parameters of the system in response to the difference between the concentration of the liquid during processing and the concentration of the setpoint.

In some embodiments, flow rate is adjusted in response to the difference between the concentration of the liquid during processing and the concentration of the setpoint.

In some embodiments, the system further comprising an analyzer, wherein the analyzer is in communication with the apparatus. In some such embodiments, the analyzer is selected from an ultra-violet/visible light spectrometer, a Raman spectrometer, a near-infrared spectrometer, a fluorescence spectrometer, a dynamic light scattering detector, a surface charge detector, a turbidity sensor, and a combination thereof.

### Methods

In some embodiments, provided herein is a method for the continuous processing of particles. In some embodiments, the method comprises: receiving a liquid at the apparatus of the invention; processing the liquid via the apparatus; and optionally, monitoring a state of the liquid during processing.

In some embodiments, processing the liquid via the apparatus comprises the liquid traveling through the membrane and the permeate attachment.

In some embodiments, processing the liquid via the apparatus comprises using one or more feedback loops.

In some embodiments, processing the liquid via the apparatus comprises using one or more analyzers in fluid communication with the retentate output of the membrane holder.

In some embodiments, processing the liquid via the apparatus comprises using one or more pump controls.

In some embodiments, processing the liquid via the apparatus comprises using one or more pressure controls.

In some embodiments, monitoring a state of the liquid during processing comprises flow rate monitoring.

In some embodiments, monitoring a state of the liquid during processing comprises pressure monitoring.

### Computer Readable Medium

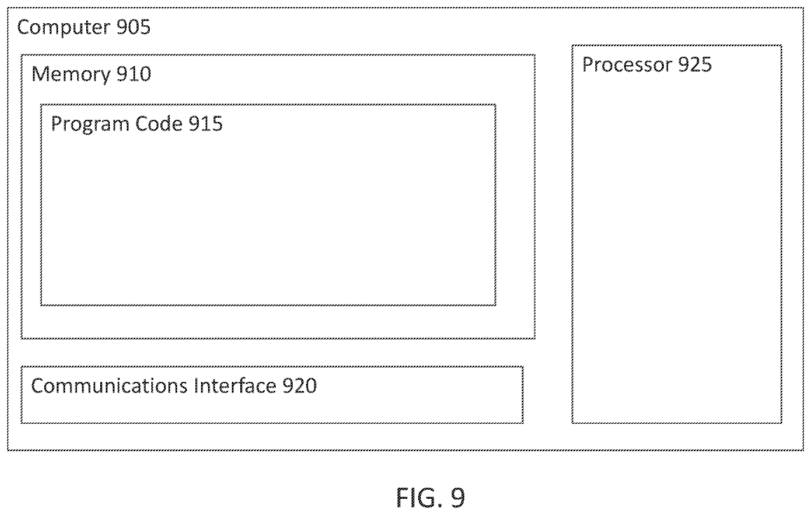

The methods and apparatus of this invention may take the form, at least partially, of program code (i.e., instructions) embodied in tangible non-transitory media, such as floppy diskettes. CD-ROMs, hard drives, random access or read only-memory, or any other machine-readable storage medium. When the program code is loaded into and executed by a machine, such as the computer 905 of FIG. 9 the machine becomes an apparatus for practicing the invention. When implemented on one or more general-purpose processors (e.g., processor 925), the program code 915 combines with such a processor 925 to provide a unique apparatus that operates analogously to specific logic circuits. As such a general-purpose digital machine can be transformed into a special purpose digital machine.

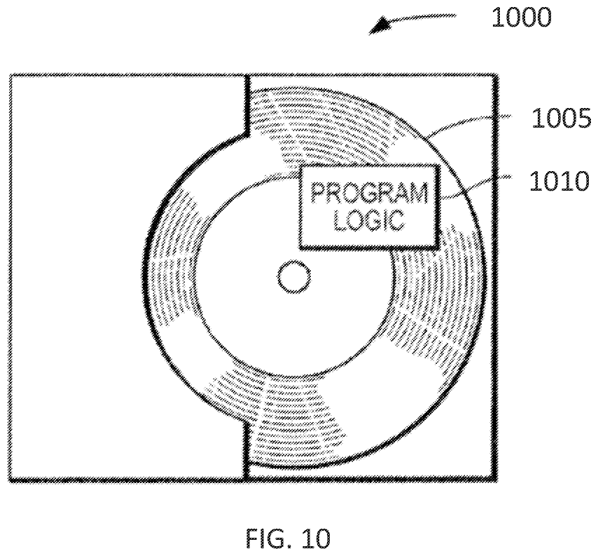

FIG. 10 shows Program Logic 1010 embodied on a computer-readable medium 1005 as shown, and wherein the Logic is encoded in computer-executable code configured for carrying out the processsc of this invention and thereby forming a Computer Program Product 1000. The logic for carrying out the method may be embodied as part of the aforementioned system, which is useful for carrying out a method described with reference to embodiments shown in, for example, FIGS. 1-8. For purposes of illustrating the present invention, the invention is described as embodied in a specific configuration and using special logical arrangements, but one skilled in the art will appreciate that the device is not limited to the specific configuration but rather only by the claims included with this specification.

Although the foregoing invention has been described in some detail for purposes of clarity of understanding, it will be apparent that certain changes and modifications may be practiced within the scope of the appended claims. Accordingly, the present implementations are to be considered as illustrative and not restrictive, and the invention is not to be limited to the details given herein but may be modified within the scope and equivalents of the appended claims. In reading the above description, persons skilled in the art will realize that there are many apparent variations that can be applied to the methods and systems described. In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

1. An apparatus, comprising:
a membrane;
a membrane holder including an output, wherein the membrane holder is operable to hold the membrane and the membrane holder has three or more ports; and
a permeate attachment coupled to the output of the membrane.

2. The apparatus of claim 1, further comprising a flow meter coupled to an output of the permeate attachment.

3. The apparatus of claim 1, further comprising a pump coupled to an input of the membrane holder.

4. The apparatus of claim 3, further comprising a flow meter disposed between the pump and the membrane holder.

5. The apparatus of claim 4, further comprising a pressure sensor coupled to the membrane holder.

6. An apparatus, comprising:
a membrane;
a membrane holder including a first output, wherein the membrane holder is operable to hold the membrane and the membrane holder has three or more ports;
a permeate attachment coupled to the first output of the membrane; and
a flow meter coupled to an output of a first pump,
wherein the flow meter is disposed between the pump and the membrane holder.

7. The apparatus of claim 1, further comprising a pressor sensor coupled to the input of the membrane holder, wherein the pressure sensor is enabled to detect a pressure of a liquid passing through the pressure sensor.

8. The apparatus of claim 1, wherein the flow meter is disposed between the first pump and the membrane holder; and a pressure sensor is coupled to the flow meter, wherein the pressure sensor is enabled to detect a pressure of a liquid passing through the pressure sensor and regulate an output of the flow meter.

9. The apparatus of claim 1, further comprising one or more heat exchangers in fluid communication with one or more flow meters.

10. The apparatus of claim 1, further comprising a pressure regulator coupled to at least one flow meter.

11. The apparatus of claim 10, wherein the pressure regulator comprises a tube.

12. The apparatus of claim 11, wherein the tube restricts liquid flow to modify a pressure of the liquid passing through the pressure sensor.

13.-14. (canceled)

15. The apparatus of claim 10, wherein the pressure regulator is a back pressure regulator and/or a pinch valve.

16. (canceled)

17. The apparatus of claim 1, further comprising a valve coupled to the permeate attachment.

18. (canceled)

19. The apparatus of claim 1, further comprising one or more vessels.

20.-27. (canceled)

28. A system, comprising:
an apparatus of claim 1;
a memory; and
a processor in communication with the memory, wherein the processor is configured to execute steps comprising:
receiving a liquid at the apparatus;
processing the liquid via the apparatus, wherein the liquid travels through the membrane and the permeate attachment; and
optionally, monitoring a state of the liquid during processing.

29.-34. (canceled)

35. The system of claim 28, further comprising a controller.

36. The system of claim 35, wherein the controller is configured to:
determine concentration of the liquid during processing;
compare said concentration to a setpoint; and
adjust one or more parameters of the system in response to the difference between the concentration of the liquid during processing and the concentration of the setpoint.

37.-39. (canceled)

40. A method for the continuous processing of particles, the method comprising: receiving a liquid at the apparatus of claim 1;
processing the liquid via the apparatus; and
optionally, monitoring a state of the liquid during processing.

41.-47. (canceled)

48. A non-transitory computer readable medium having stored thereon instructions, that when executed by one or more processors, cause a system for the continuous processing of particles to perform operations comprising:
receiving a liquid at the apparatus of claim 1;
processing the liquid via the apparatus; and
optionally, monitoring a state of the liquid during processing.

49.-56. (canceled)
